(19) United States
(12) Patent Application Publication
(10) Pub. No.: US 2024/0052527 A1
(43) Pub. Date: Feb. 15, 2024

(54) Polyvinyl Alcohol Fibres and Spunbond Fibrous Products

(71) Applicant: Aquapak IP Limited, Birmingham (GB)

(72) Inventors: John Williams, Chirbury (GB); Sian Griffiths, Glan Conwy (GB); Robert Ashworth, Colwyn Bay (GB); Jack Eaton, Leeds (GB)

(21) Appl. No.: 18/233,086

(22) Filed: Aug. 11, 2023

(30) Foreign Application Priority Data
Aug. 13, 2022 (EP) 22190327.1
Aug. 13, 2022 (EP) 22190328.9
Aug. 13, 2022 (EP) 22190330.5
Aug. 13, 2022 (EP) 22190331.3

(51) Int. Cl. D01F 6/50; D01D 5/10

(52) U.S. Cl. CPC D01F 6/50; D01D 5/10

(57) ABSTRACT

This invention relates to polyvinyl alcohol fibers, methods of making polyvinyl alcohol fibers and products manufactured from polyvinyl alcohol fibers. The invention relates particularly but not exclusively to products comprising spunbond polyvinyl alcohol fibers, methods of making spunbond polyvinyl alcohol fibers and products incorporating such fibers.

### CROSS-REFERENCE TO RELATED APPLICATION(S)

This application claims priority under 35 USC § 119(a) to EP Patent Application No. 22190328.9, filed Aug. 13, 2022, EP Patent Application No. 22190330.5, filed Aug. 13, 2022, EP Patent Application No. 22190331.3, filed Aug. 13, 2022, and EP Patent Application No. 22190327.1, filed Aug. 13, 2022, which are hereby incorporated by reference in their entirety for all purposes.

### TECHNICAL FIELD

This invention relates to polyvinyl alcohol fibers, methods of making polyvinyl alcohol fibers and products manufactured from polyvinyl alcohol fibers. The invention relates particularly but not exclusively to products comprising spunbond polyvinyl alcohol fibers, methods of making spunbond polyvinyl alcohol fibers and products incorporating such fibers.

### BACKGROUND

Polyvinyl alcohol has many advantages in comparison to polymers which are traditionally used for manufacture of non-woven fiber products. Polyvinyl alcohol is soluble in water, particularly when heated, facilitating reclamation, recycling and environmental degradation.

Polyvinyl alcohol is manufactured by hydrolysis of homopolymer or co-polymers of polyvinyl acetate. Polyvinyl alcohol manufactured by partial or complete hydrolysis of homopolymeric polyvinyl acetate is referred to as homopolymeric polyvinyl alcohol. The degree of hydrolysis determines the properties of the resultant polymer. Co-polymeric polyvinyl alcohols or homopolymeric polyvinyl alcohol with a low degree (LD) of hydrolysis are easy to process but have inferior mechanical and chemical properties. Homopolymeric polyvinyl alcohol with a high degree (HD) of hydrolysis, for example 85% or greater, has superior properties but is not processable without degradation under conditions using apparatus employed for manufacture of polyolefin non-woven fibers.

Polyvinyl alcohol is soluble in water and fibers have traditionally been made by solution spinning methods using polyvinyl alcohol with a low degree (LD) of hydrolysis.

In order to enhance water resistance, thermal e.g., hot drawing and chemical e.g., acetylation steps have been required.

WO2017/046361 discloses a method for manufacture of processable polyvinyl alcohol having a degree of hydrolysis of 98% or greater. WO2022/008521 discloses a method for manufacture of processable polyvinyl alcohol having a degree of hydrolysis in the range of 93% to 98% or more. WO2022/008516 discloses a method for manufacture of plasticized polyvinyl alcohol having a degree of hydrolysis of 93% to 98% or more.

### SUMMARY

According to a first aspect of the present invention, a method of manufacture of a nonwoven product comprising polyvinyl alcohol fibers is provided. The method comprises the steps of providing a polyvinyl alcohol composition comprising homopolymeric polyvinyl alcohol having a degree of hydrolysis of 88% to 98% or greater; and a weight average molecular weight in the range from 14,000 to 35,000; a plasticizer selected from the group consisting of: diglycerol, triglycerol, fructose, ribose, xylose, D-mannitol, triacetin, pentaerythritol, dipentaerythritol, methyl pentanediol, 1,2-propanediol, 1,4-butanediol, 2-hydroxy-1,3-propanediol, 3-methyl-1,3-butanediol, 3,3-dimethyl-1,2-butanediol, polyethylene glycol 300, polyethylene glycol 400, alkoxylated polyethylene glycol, caprolactam, tricyclic trimethylolpropane formal, rosin esters, erucamide, and mixtures thereof; and an optional stabilizer selected from the group consisting of: sodium stearate, potassium oleate, sodium benzoate, calcium stearate, stearic acid, dimethyl pentane diol, propionic acid and mixtures thereof; melting the composition at a temperature from 190° C. to 240° C. to form a molten polymer; wherein the molten polymer is spunbond by the steps of extrusion of the polymer through a die having a spinneret to form fibers of molten polymer; and the fibers being drawn using an airflow, deposited on a moving collector and allowed to solidify to form a spunbond nonwoven fiber web.

According to a second aspect of the present invention there is provided spunbond homopolymeric polyvinyl alcohol fiber having a degree of hydrolysis of 88 wt % to 98 wt % or greater and a molecular weight from 14,000 to 35,000. The fiber may be made in accordance with the first aspect of the present invention.

According to a third aspect of the present invention, there is provided a spunbond non-woven fiber product comprising homopolymeric polyvinyl alcohol fiber having a degree of hydrolysis of 88 wt % to 98 wt % or greater and a molecular weight from 14,000 to 35,000. The product may be made in accordance with the method of the first aspect of the present invention.

### BRIEF DESCRIPTION OF THE DRAWINGS

FIG. 1 is a diagrammatic view of the spunbonding apparatus in accordance with this invention.

### DETAILED DESCRIPTION

The spunbond process is a continuous converting technology for converting thermoplastic polymer into a non-woven fabric. The polymer pellets are melted and the melt is forced by spin pumps through special spinnerets having a large number of holes. At the exits of the spinnerets, molten polymers are cooled and drawn by blowing air at high pressure in order to impart strength to the individual filaments. The attenuation and stretching lead to molecular orientation of the polymer during formation of continuous filaments. The filaments may then be randomly laid on a conveyor belt forming a continuous filament non-woven fabric. Thermal bonding or calendaring can be used to bond spun bonded webs.

For spunbond applications, the degree of hydrolysis may be 93% to 98%, for example 93% to 97%, for example 93% to 95%. The polyvinyl alcohol may be manufactured by hydrolysis of homopolymeric polyvinyl acetate, wherein the extent of hydrolysis is in the range from 88 wt % up to 98 wt %, for example 93 wt % to less than 98 wt %, for example 93 wt % to 97 wt %, for example 93 wt % to 95 wt %.

For spunbond applications, the molecular weight of the homopolymeric polyvinyl alcohol may be in the range from 14,000 to 22,000, for example, 15,000 to 20,000, for example 16,000 to 20,000.

Molecular weights in this specification are weight average molecular weights and are measured using conventional liquid chromatographic techniques.

In embodiments, the composition may be melted at a temperature from 220° C. to 240° C. The polyvinyl alcohol composition of this invention may have a melt flow index (MFI) of 30 to 70 g/10 min, for example 30 to 60 g/10 min, for example 30 to 50 g/10 min. Melt flow indices referred to in this specification are determined at 230° C. using a weight of 10 kg by conventional techniques.

The polyvinyl alcohol composition of this invention is stable at the temperature at which it is melted and extruded. Polyvinyl alcohol, not containing a plasticizer and stabilizer as disclosed herein, particularly the homopolymer having a high degree of hydrolysis, may be liable to decompose at the temperatures required for melting and extrusion processing.

The present invention provides an economical one-step process for formation of spunbond homopolymeric non-woven polyvinyl alcohol products directly from extrusion of the polymer composition.

Advantageous polyvinyl alcohol fibers of this invention are capable of being processed on a commercial scale, using conventional spunbonding apparatus.

The filaments may be heat treated after solidification. Heat treatment may be carried out to modify the degree of crystallinity of the filaments. Control of the degree of crystallinity may allow control of the tensile strength of the fibers and of a fabric composed of the fibers. The sensitivity of the fibers or fabric to exposure to water during use may also be reduced.

Heat treatment may be provided by calendaring the fibers or fabric by passage of the fibers or fabric between rollers maintained in a predetermined temperature range. The temperature of the rollers, or calendaring temperature may be in the range of 100° C. to 150° C., for example, 105° C. to 145° C., for example 108° C. to 142° C.

The polyvinyl alcohol composition is preferably stable at the temperature at which it is melted and extruded. Polyvinyl alcohol, not containing a plasticizer and stabilizer as disclosed herein, particularly the homopolymer having a high degree of hydrolysis, is liable to decompose at the temperatures required for melting and extrusion processing.

Polyvinyl alcohol according to this invention can be processed into filaments or fibers. These may be converted by crimping and cutting into staple fibers suitable for carding, wet laying and air laying to form a range of non-woven products.

Advantageous polyvinyl alcohol fibers of this invention are capable of being processed on a commercial scale, for example using apparatus running at 4,500 m·min⁻¹.

The stabilized polyvinyl alcohol polymers used in this invention may be manufactured in accordance with WO2022/008516 and WO2022/008521, the disclosures of which are incorporated into this specification by reference for all purposes.

The polyvinyl alcohol composition may be made by a method comprising the steps of introducing into a mixing reactor a polyvinyl alcohol polymer comprising homopolymeric polyvinyl alcohol or a blend thereof having a degree of hydrolysis in the range of 88 wt % to 98 wt % or more; where the mixing reactor comprises a blending chamber having a primary inlet, a primary outlet and at least two inter-engaging components extending between the primary inlet and primary outlet, the components being arranged to apply a shearing force to the polymer while the polymer is conveyed by the components from the inlet through a reaction zone to the outlet; one or more secondary inlets located downstream from the primary inlet for introducing reactants comprising a processing aid, a plasticizer and a reactive stabilizer to the chamber to form a reaction mixture; where the plasticizer is selected from the group disclosed above; where the reactive stabilizer, when present, is selected from the group consisting of sodium stearate, potassium oleate, sodium benzoate, calcium stearate, stearic acid, dimethyl propionic acid, and mixtures thereof; where the blending chamber comprises a plurality of heated regions arranged so that the mixture is subjected to a temperature profile whereby the temperature increases from the inlet to the outlet; a secondary outlet located between the reaction zone and primary outlet arranged to allow removal of processing aid from the chamber; reacting the processing agent, plasticizer and polymer in the reaction zone to form plasticized polymer; and allowing the plasticized polymer to pass from the primary outlet.

Use of a reactive mixing apparatus, typically an extruder in accordance with this invention allows the processing aid and plasticizer to be reacted with the polyvinyl alcohol or blend thereof, without decomposition of the polymer followed by removal of all or most of the processing aid from the secondary outlet to give plasticized polyvinyl alcohol or a blend thereof.

Use of a reactive stabilizer may result in an advantageous reduction in the extent of degradation during melt processing. This allows homopolymeric polyvinyl alcohol having a high degree of hydrolysis, for example 88 wt % or higher to be processed to form fibers or pellets from which fibers may be extruded and formed into a spunbond web.

The reactive stabilizer may be used in an amount of about 0.1 wt % to about 5 wt %, for example about 0.1 wt % to about 3 wt %, for example 0.1 wt % to about 1.5 wt %, for example from about 0.2 wt % to about 0.5 wt %, for example about 0.25 wt %.

The reactive stabilizers of this invention may decrease the extent of degradation of the polymer during processing. Homopolymeric polyvinyl alcohol has been difficult to process due to degradation at the high temperatures required. The liability of degradation has led to use of polyvinyl alcohol co-polymers with a consequent loss of engineering properties. This can be seen by UV spectral analysis of the amount of conjugation present in the polymer. Sodium benzoate has been found to be particularly effective.

Use of homopolymeric polyvinyl alcohol is particularly advantageous. Homopolymeric polyvinyl alcohol is manufactured by hydrolysis of homopolymeric polyvinyl acetate, the degree of hydrolysis being 93 wt % or more in embodiments of this invention. Polyvinyl alcohol co-polymers made by hydrolysis of polyvinyl acetate co-polymers have inferior properties compared to homopolymeric polyvinyl alcohol. Homopolymeric polyvinyl alcohol may exhibit advantageous properties.

Spunbond polyvinyl alcohol polymer fibers of this invention may have high tensile strength and flexibility.

A blend of two or more polyvinyl alcohol polymers may be employed, for example a blend of two polyvinyl alcohol polymers with a relatively high molecular weight and a relatively low molecular weight respectively.

A blend of polyvinyl alcohols with the same molecular weight and different degrees of hydrolysis can be combined. Blending different polyvinyl alcohol grades together enables the properties of the resultant polymer to be enhanced, for example melt strength.

For fiber production a blend of two polyvinyl alcohol polymers with a molecular weight in the range 22,000 to 38,000, a first polymer having a low degree of hydrolysis and a second polymer having a high degree of hydrolysis may be blended in a ratio of 40:60 to 60:40, for example about 50:50 by weight.

The blends of different molecular weight polymers employed are selected in accordance with the physical properties required in the finished product. This may require different molecular weight materials being used. Use of more than two different molecular weight polymers may be advantageous. The use of a single molecular weight polymer is not precluded.

Use of a blend may allow control of the viscosity of the polymer. Selection of a stabilizer in accordance with the present invention allows use of blends of a desired viscosity without a loss of other properties. Alternatively, use of a blend may permit use of polyvinyl alcohol with one or more stabilizers while maintaining viscosity or other properties to permit manufacture of pellets or films.

The processing aid is preferably water. Alternatively, the processing aid may comprise a mixture of water and one or more hydroxyl compound with a boiling point less than the boiling point or melting point of the plasticizer. Use of water is preferred for cost and environmental reasons.

Two or more plasticizers may be employed. When a mixture of plasticizers is employed, a binary mixture may be preferred. In an embodiment, the plasticizer or plasticizers may be selected from the group consisting of: diglycerol, triglycerol, xylose, D-mannitol, triacetin, dipentaerythritol, 1,4-butanediol, 3,3-dimethyl-1,2-butanediol, and caprolactam. The total amount of plasticizers in the formulation may be from about 15 wt % to about 30 wt %.

Polymer compositions of this invention may not include any or any substantial amount of a water-soluble salt, wax, oil, or ethylene homopolymer or copolymer.

The method of this invention provides many advantages. The method allows formation of thermally processable polyvinyl alcohol which can be used to create economical fibers that are highly functional while eliminating plastic pollution. Polyvinyl alcohol is water-soluble, non-toxic to the environment and inherently biodegradable. Hydrophilic polymers, for example, polyvinyl alcohol degrade environmentally faster than hydrophobic polymers and do not show bioaccumulation. Thermoplastic polyvinyl alcohol can be mechanically recycled into pellets for repeated use.

Spunbond fibers of this invention may have an advantageous smaller diameter. Fibers having a smaller diameter have a greater surface area which may be advantageous for air filtration, for example in face masks. Finer fibers may also be softer in texture. Furthermore, finer fibers may also have an increased rate of biodegradation after use.

According to a second aspect of the present invention there is provided spunbond homopolymeric polyvinyl alcohol fiber having a degree of hydrolysis of 88 wt % to 98 wt % or greater and a molecular weight from 14,000 to 35,000. The fiber may be made in accordance with the first aspect of the present invention.

According to a third aspect of the present invention, there is provided a spunbond non-woven fiber product comprising homopolymeric polyvinyl alcohol fiber having a degree of hydrolysis of 88 wt % to 98 wt % or greater and a molecular weight from 14,000 to 35,000. The product may be made in accordance with the method of the first aspect of the present invention.

A non-woven product is defined by ISO9092 as an engineered fibrous assembly, primarily planar, which has been given a designed level of structural integrity by physical and/or chemical means, excluding weaving, knitting or paper making.

Homopolymeric polyvinyl alcohol fibers of this invention provide many advantages in comparison to previously available polyvinyl alcohol containing fibers. The fibers of this invention and products made from these fibers exhibit improved tensile strength, barrier properties, water solubility and biodegradability. Homopolymeric polyvinyl alcohol fibers may unexpectedly exhibit all of these properties. In comparison, copolymers have only been able to compromise and provide one or more of these properties at the expense of other properties. The fibers and products of the present invention have a desirable monomaterial structure which does not suffer from this disadvantage.

The following is a summary of exemplary spunbonding parameters in accordance with this invention. Polymer compositions A to G (see below) may be particularly advantageous.

The die temperature may be in the range 205° C. to 240° C. Increasing the die temperature may result in a reduction of viscosity of the polyvinyl alcohol polymer. Each grade of polyvinyl alcohol polymer has a threshold temperature, in the range 230° C. to 250° C. beyond which the polymer may crosslink resulting in blockage of the spinneret.

Air pressure at the aspirator may be 50 to 110 kPa. The air pressure may have a positive impact on filament fineness. The air pressure may be increased to produce finer filaments. However, there is an optimum value in order to prevent melt breakage. This parameter may be influenced by both the intrinsic characteristics of the polymer, for example molecular weight, linearity, and crystallinity and by other processing parameters.

The aspirator to collector distance may be 0.15 to 0.20 m. The distance between the aspirator and the collector may be optimized to achieve good collection of the filaments.

The extrusion speed may be in the range from 2.42 to 0.97 kg/h dependent on the equipment used. Exemplary polyvinyl alcohol compositions in accordance with this invention may be processed successfully at high and low extrusion speeds. Higher extrusion speeds may result in coarser filament diameters.

The filaments may be collected on a moving conveyor. The collected filaments may be calendared by passage through a nip between compaction rollers followed by calendaring between heated rollers before collection onto a winder.

The calendaring temperature may be in the range 108° C. to 142° C. Increasing the calendaring temperature may improve both the tensile strength of the fabric and reduce the sensitivity of the fabric when exposed to water.

Polyvinyl alcohol spun bond fabrics of this invention exhibit filament diameters within the range of typical spun bond fabrics and have high air permeability. The fabrics showed swelling and partial dissolution in contact with water. The fabrics find application in the manufacture of dry wipes, hygiene top sheets and core wraps, filtration and personal protective equipment, for example face masks.

Percentages and other quantities referred to in this specification are by weight unless stated otherwise and are selected from any ranges quoted to total 100%.

The invention is further described by means of example but not in any limitative sense, with reference to the accompanying drawings.

### EXAMPLE

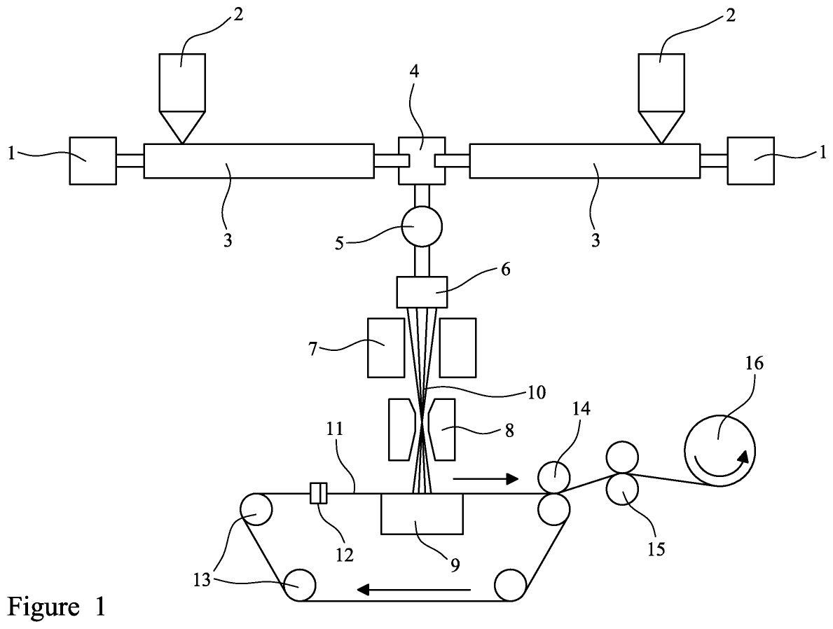

FIG. 1 is a diagrammatic view of spunbonding apparatus in accordance with this invention. The apparatus comprises two extruders (3) driven by extruder drives (1). Polymer hoppers (2) supply polymer pellets to the extruders (3). The extruders (3) feed molten polymer to a filter (4) and pump (5). The pump supplies polymer to a spin pack (6) which extrudes molten spun fibers (10) through an air quenching unit (7) and an attenuator/aspirator (8). The spun fibers are deposited as a non-woven web on a moving forming belt (11). The forming belt is an endless conveyor located on guide rollers (13). An edge guide (12) is provided. The belt (11) passes between a pair of compaction rollers (14) followed by two heated calendared rollers (15). The finished non-woven web is collected on a winder (16).

In embodiments of the present invention the following polyvinyl alcohol homopolymer compositions may be employed.

Polymer composition A

| | |
|---|---|
| PVOH; degree of hydrolysis 98%; low viscosity | 35.97% |
| PVOH; degree of hydrolysis 89%; low viscosity | 35.97% |
| Trimethylol propane | 14.37% |
| Sodium benzoate | 0.21% |
| Glycerol | 4.29% |
| Water | 9.20% |

Polymer composition B

| | |
|---|---|
| PVOH; degree of hydrolysis 99%; high viscosity | 7.193% |
| PVOH; degree of hydrolysis 98%; low viscosity | 64.737% |
| Trimethylol propane | 14.37% |
| Sodium benzoate | 0.21 |
| Glycerol | 4.29% |
| Water | 9.20% |

Polymer composition C

| | |
|---|---|
| PVOH; degree of hydrolysis 98%; low viscosity | 35.87% |
| PVOH; degree of hydrolysis 89%; low viscosity | 35.87% |
| Di-pentaerythritol | 6.21% |
| Triacetin | 12.41% |
| Sodium benzoate | 0.25% |
| Water | 9.39% |

Polymer composition D

| | |
|---|---|
| PVOH; degree of hydrolysis 98%; low viscosity | 22.61% |
| PVOH; degree of hydrolysis 97%; medium viscosity | 52.76% |
| Di-pentaerythritol | 4.99% |
| Sodium benzoate | 0.25% |
| Triacetin | 10.00% |
| Water | 9.39% |

Polymer composition E

| | |
|---|---|
| PVOH; degree of hydrolysis 98%; low viscosity | 25.20% |
| PVOH; degree of hydrolysis 98%; low viscosity | 5.20% |
| PVOH; degree of hydrolysis 89%; low viscosity | 25.21% |
| Dipentaerythritol | 5.00% |
| Triacetin | 10.00% |
| Water | 9.39% |

Polymer composition F

| | |
|---|---|
| PVOH; degree of hydrolysis 98%; low viscosity | 27.33% |
| PVOH; degree of hydrolysis 98%; low viscosity | 27.33% |
| PVOH; degree of hydrolysis 89%; low viscosity | 27.33% |
| Dipentaerythritol | 8.00% |
| Methylpentanediol | 5.50% |
| Glycerol | 4.50% |

Polymer composition G

| | |
|---|---|
| PVOH; degree of hydrolysis 98%; low viscosity | 72.45% |
| PVOH; degree of hydrolysis 99%; high viscosity | 9.20% |
| Dipentaerythritol | 7.95% |
| Methylpentanediol | 5.63% |
| Glycerol | 4.50% |
| Sodium benzoate | 0.27% |

### Example 1

A spunbonded non-woven fabric was manufactured as disclosed in this specification. Polymer composition A was employed. The following properties were observed.

The areal density was in the range of 52 to 62 g/m 2. The fabrics of this invention had medium to high areal densities compared to typical spunbond fabrics compared to typical spunbond fabrics comprised of polyolefin fibers.

The thickness was 0.25 to 0.32 mm. The fabrics produced had thicknesses in the typical range of spunbonded fabrics (0.2 to 1.5 mm).

The filament diameter was in the range 10 to 31 μm. The filament diameters were in the typical range for spunbond fabrics (15 to 35 m). The air permeability at 200 Pa was in the range 2,242 to 4,876 l·m⁻² s⁻¹. The spun bond fabrics of this invention showed high air permeability. The fabrics of this invention exhibit good breathability and low-pressure drop-in use.

The tensile strength, MD was in the range 5-13 N/25 mm. The tensile strength of the polyvinyl alcohol non-woven fabrics was sufficient to enable converting processes and wipes applications. Filament drawing may be increased to improve tensile strength.

What is claimed is:

1. A method of manufacture of a nonwoven product comprising polyvinyl alcohol fibers, the method comprising the steps of
providing a polyvinyl alcohol composition comprising homopolymeric polyvinyl alcohol having a degree of hydrolysis of 88% to 98% or greater; and a weight average molecular weight in the range from 14,000 to 35,000;
a plasticizer selected from the group consisting of: diglycerol, triglycerol, fructose, ribose, xylose, D-mannitol, triacetin, pentaerythritol, dipentaerythritol, methyl pentanediol, 1,2-propanediol, 1,4-butanediol, 2-hydroxy-1,3-propanediol, 3-methyl-1,3-butanediol, 3,3-dimethyl-1,2-butanediol, polyethylene glycol 300, polyethylene glycol 400, alkoxylated polyethylene glycol, caprolactam, tricyclic trimethylolpropane formal, rosin esters, erucamide, and mixtures thereof; and
an optional stabilizer selected from the group consisting of sodium stearate, potassium oleate, sodium benzoate, calcium stearate, stearic acid, dimethyl pentane diol, propionic acid and mixtures thereof;
melting the composition at a temperature from 190° C. to 240° C. to form a molten polymer;
wherein the molten polymer is spunbond by the steps of:
extrusion of the polymer through a die having a spinneret to form fibers of molten polymer;
the fibers being drawn using an airflow, deposited on a moving collector and allowed to solidify to form a spunbond nonwoven fiber web.

2. A method as claimed in claim 1, wherein the nonwoven fiber web is calendared at a temperature in the range of 100° C. to 150° C.

3. A method as claimed in claim 2, wherein the nonwoven fiber web is calendared at a temperature in the range of 108° C. to 142° C.

4. A method as claimed in claim 1, wherein the molten polymer is extruded from a die having a temperature in the range of 205° C. to 227° C.

5. A method as claimed in claim 1, wherein the airflow is from an aspirator, and wherein the air pressure at the aspirator is 50 to 110 kPa.

6. A method as claimed in claim 1, wherein the airflow is from an aspirator and the aspirator to collector distance is 0.15 m to 0.20 m.

7. A spunbond nonwoven fabric comprising homopolymeric polyvinyl alcohol having a degree of hydrolysis of 88 wt % to 98 wt % or greater and a molecular weight in the range from 14,000 to 35,000.

8. A spunbond nonwoven homopolymeric polyvinyl alcohol fabric made by the method of any of claim 1.

9. A product incorporating a spunbond fabric as claimed in claim 8.

10. A product incorporating a spunbond fabric as claimed in claim 8 wherein the product is selected from the group consisting of: dry wipes, hygiene top sheets and core wraps, filters, face masks and personal protective equipment.

11. A spunbond non-woven polyvinyl alcohol fabric, the polyvinyl alcohol being homopolymeric and having a degree of hydrolysis of 88 wt % to 98 wt % or greater.

12. A product incorporating a spunbond fabric as claimed in claim 11, wherein the product is selected from dry wipes, hygiene top sheets and core wraps, filters, face masks and personal protective equipment.
